(19) United States
(12) Patent Application Publication
(10) Pub. No.: US 2010/0240291 A1
(43) Pub. Date: Sep. 23, 2010

(54) OUTFLOW VALVE POSITION INDICATION

(75) Inventors: Justin A. Tanner, Queen Creek, AZ (US); Darrell Horner, Oro Valley, AZ (US); Ross F. Meyer, Mesa, AZ (US); Ron Friestad, LaVerne, CA (US); Kevin Prodromides, Tucson, AZ (US)

Correspondence Address: HONEYWELL/IFL;Patent Services, 101 Columbia Road, P.O.Box 2245, Morristown, NJ, 07962-2245, US

(73) Assignee: Honeywell International Inc., Morristown, NJ (US)

(21) Appl. No.: 12/409,286

(22) Filed: Mar. 23, 2009

(51) Int. Cl. B64D 13/00; F15C 3/00

(52) U.S. Cl. 454/72; 137/899.2

(57) ABSTRACT

An aircraft cabin pressure control system outflow valve includes a frame, a valve element, and a position sensor. The frame is configured to be mounted on an aircraft exterior skin. The valve element is rotationally coupled to the frame, and is coupled to receive an actuation drive force. The valve element is responsive to the actuation drive force to rotate to a position between a closed position and a plurality of open positions. The position sensor is coupled to the frame and is configured to directly sense rotation of the valve element and supply a position signal representative of valve element position.

### TECHNICAL FIELD

The present invention relates generally to aircraft systems and, more particularly, to position indication of an aircraft cabin pressure control system outflow valve.

### BACKGROUND

Aircraft are commonly equipped with Cabin Pressure Control Systems (CPCSs), which maintain cabin air pressure within a desired range to increase passenger comfort during flight. A typical CPCS may include a controller, an actuator, and an outflow valve. The outflow valve is typically mounted on either a bulkhead of the aircraft or on the outer skin surface of the aircraft, and selectively fluidly couples the aircraft cabin and the atmosphere outside of the aircraft. During operation, the controller commands the actuator to move the outflow valve to various positions to control the rate at which pressurized air is transferred between the aircraft cabin and the outside atmosphere, to thereby control the pressure and/or rate of change of pressure within the aircraft cabin. The controller may be configured to command the actuator to modulate the outflow valve in accordance with a predetermined schedule or as a function of one or more operational criteria. For example, the CPCS may additionally include one or more cabin pressures to sense cabin pressure and supply pressure signals representative thereof to the controller. By actively modulating the outflow valve, the controller may maintain aircraft cabin pressure and/or aircraft cabin pressure rate of change within a desired range. Furthermore, the outflow valve may be positioned on the aircraft outer skin surface such that when pressurized air is exhausted from the cabin, the exhausted air may provide additional forward thrust to the aircraft. Thus, outflow valves may also be sometimes referred to as thrust recovery valves. Modern thrust recovery valves often contain two valve door elements to optimize the forward thrust that is created.

In addition to the above, some CPCSs include outflow valve position sensors to sense outflow valve position. The outflow valve position sensors, when included, typically provide only an indication of outflow valve position, and may be used for control and/or indication. In any case, when used on skin mounted thrust recovery valves containing two doors, the position sensors presently used are configured in a manner that valve position is only indirectly sensed. For example, the outflow valve position sensor may be mounted on the outflow valve actuator, and senses the position of an actuator component. The position of the outflow valve is then derived from the sensed actuator component position.

The above-described manner of sensing and determining outflow valve position, while generally safe, does suffer certain drawbacks. For example, because the outflow valve actuator may be a relatively complex device, with multiple motors and gear sets, variation from actuator to actuator may exist. Moreover, various linkages between the actuator output and the outflow valve doors may also exhibit further variations. As such, if the actuator is replaced, precise re-rigging of the replacement actuator to the proper position may be needed to prevent damage to the outflow valve and/or gears. Moreover, precise re-rigging of the replacement actuator may be needed to ensure the valve can meet a full-closed position and does not excessively leak. This re-rigging may take excessive production and/or maintenance time, with concomitantly excessive costs. Furthermore, the position sensing devices that are typically used may be relatively expensive and/or insufficiently robust.

Hence, there is a need for a method and means for sensing outflow valve position that is more accurate than what is presently done and/or does not rely on precise re-rigging of a replacement actuator and/or does not rely on relatively expensive or insufficiently robust position sensors. The present invention addresses one or more of these needs.

### BRIEF SUMMARY

In one embodiment, and by way of example only, an aircraft cabin pressure control system outflow valve includes a frame, a valve element, and a position sensor. The frame is configured to be mounted on an aircraft exterior skin. The valve element is rotationally coupled to the frame, and is coupled to receive an actuation drive force. The valve element is responsive to the actuation drive force to rotate to a position between a closed position and a plurality of open positions. The position sensor is coupled to the frame and is configured to directly sense rotation of the valve element and supply a position signal representative of valve element position.

In another exemplary embodiment, an aircraft cabin pressure control system outflow valve includes a frame, an actuator, a first door, a second door, a first position sensor, and a second position sensor. The frame is configured to be mounted on an aircraft exterior skin. The actuator is coupled to the frame and is operable to supply an actuation drive force. The first door is rotationally coupled to the frame and is further coupled to receive the actuation drive force supplied by the actuator. The first door is responsive to the actuation drive force to rotate to a position between a closed position and a plurality of open positions. The second door is rotationally coupled to the frame and is further coupled to the first door. The second door is responsive to rotation of the first door to simultaneously rotate therewith to a position between a closed position and a plurality of open positions. The first position sensor is coupled to the frame and is configured to directly sense rotation of the first door and supply a position signal representative of first door position. The second position sensor is coupled to the frame and is configured to directly sense rotation of the second door and supply a position signal representative of second door position.

In still another exemplary embodiment, an aircraft cabin pressure control system includes a controller, an actuator, and an outflow valve. The actuator is coupled to receive actuation commands from the controller and is operable, in response thereto, to supply an actuation drive force. The outflow valve is coupled to receive the actuation drive force, and includes a frame, a valve element, and a position sensor. The frame is configured to be mounted on an aircraft exterior skin. The valve element is rotationally coupled to the frame, and is coupled to receive the actuation drive force. The valve element is responsive to the actuation drive force to rotate to a position between a closed position and a plurality of open positions. The position sensor is coupled to the frame and is configured to directly sense rotation of the valve element and supply a position signal representative of valve element position.

Other desirable features and characteristics of the present invention will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 is a functional block diagram of an exemplary cabin pressure control system (CPCS);

FIG. 2 is an isometric view of an exemplary embodiment of an outflow valve that may be used to implement the exemplary CPCS shown in FIG. 1;

FIGS. 3 and 4 are side cross-sectional views of the exemplary outflow valve taken along line 3-3 in FIG. 2, with the outflow valve in the closed and full-open positions, respectively;

FIG. 5 is close-up view cross-section view of an exemplary magnetic position sensor coupled to, and used to sense the position of, the exemplary outflow valve of FIGS. 2-4; and

FIGS. 6-8 are close-up views of a portion of the exemplary outflow valve of FIGS. 2-4 depicting various configurations of valve pins that may be used to implement the exemplary outflow valve.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

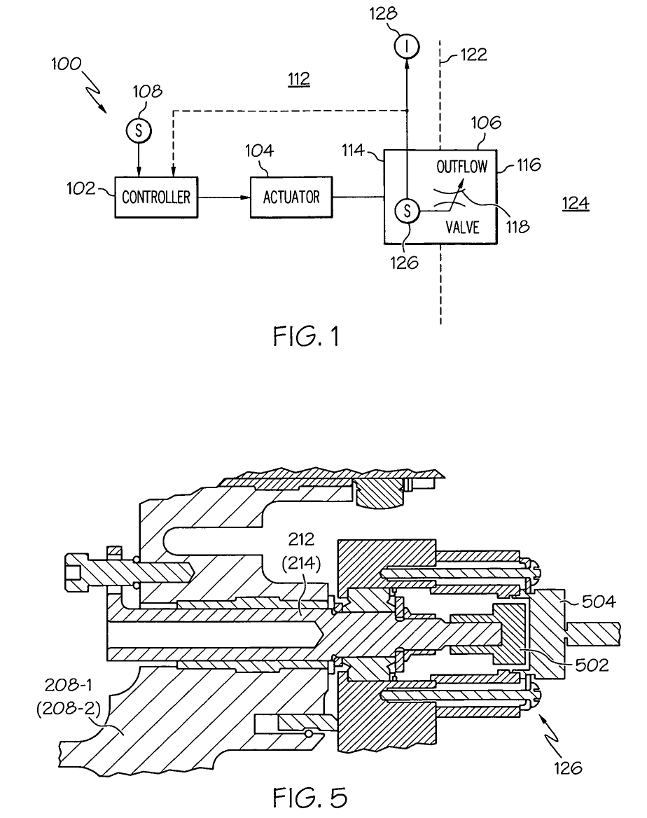

Turning first to FIG. 1, a simplified block diagram of an exemplary aircraft cabin pressure control system (CPCS) 100 is depicted. In the depicted embodiment, the CPCS includes a controller 102, an actuator 104, and an outflow valve 106. The controller 102 is operatively (e.g., electrically) coupled to the actuator 104, which is, in turn, mechanically coupled to the outflow valve 106. During operation of the CPCS 100, the controller 102 commands the actuator 104 to move the outflow valve 106 to various positions, to thereby modulate cabin pressure and/or cabin pressure rate-of-change.

It will be appreciated that the controller 102 may command the actuator 104 to move the outflow valve 106 in accordance with a predetermined schedule or as a function of one or more sensed parameters. In the depicted embodiment, the CPCS 100 further includes one or more cabin pressure sensors 108 (only one shown for clarity) that sense pressure within the aircraft cabin 112 and supply a cabin pressure sensor signal representative thereof to the controller 102. It will additionally be appreciated that the CPCS 100 may be implemented with various other sensors, such as one or more non-illustrated cabin temperature sensors, one or more non-illustrated cabin-to-atmosphere differential pressure sensors, and one or more non-illustrated atmospheric temperature sensors, just to name a few.

The outflow valve 106 includes an inlet flow port 114, an outlet flow port 116, and an interposed valve element 118. The outflow valve 106 is, for example, preferably mounted on the aircraft exterior skin 122 such that the inlet flow port 114 is exposed to the aircraft cabin 112 and the outlet flow port 116 is exposed to the atmosphere outside of the aircraft 124. Thus, during flight the pressure in the aircraft cabin 112 (e.g., cabin altitude) and/or the rate of change of aircraft cabin altitude, can be controlled by positioning the valve element 118, via the actuator 104. In one specific implementation, the outflow valve 106 is located in the rear underbelly of the aircraft proximate the tail. Moreover, in some implementations, the outflow valve 106 may be positioned so that additional forward thrust is supplied to the aircraft when pressurized air is venting from the aircraft cabin 112 to the atmosphere 124 outside the aircraft. It will be appreciated that the outflow valve 106 may be variously configured to implement this functionality. One particular physical implementation will be described further below. Before doing so, however, the remainder of the CPCS 100 depicted in FIG. 1 will be described.

The CPCS 100 additionally includes an outflow valve position sensor 126. The position sensor 126 is configured to directly sense movement of the variable area flow orifice 118, and supplies a position signal representative of variable area flow orifice position. In most embodiments, the position signal is supplied to one or more indicators 128 that provide a visual indication of variable area flow orifice position to an observer. In other embodiments, as shown in phantom in FIG. 1, the position signal may instead or additionally be supplied to the controller 102. The controller 102 may use the position signal as feedback to a control law within the controller 102, and/or the controller 102 may use the signal to provide a visual indication, and/or the controller 102 may route the position signal to one or more external indicators, such as the indicator 128 depicted in FIG. 1. It will be appreciated that although the outflow valve 106 is depicted in FIG. 1 with only a single position sensor 126, it may, and preferably does, include more than one position sensor. It will additionally be appreciated that the particular type of sensor used to implement the position sensor 126 may vary. Particular preferred types of position sensors 126 will be described below in conjunction with a description of a particular physical implementation of the outflow valve 106, which will now be provided.

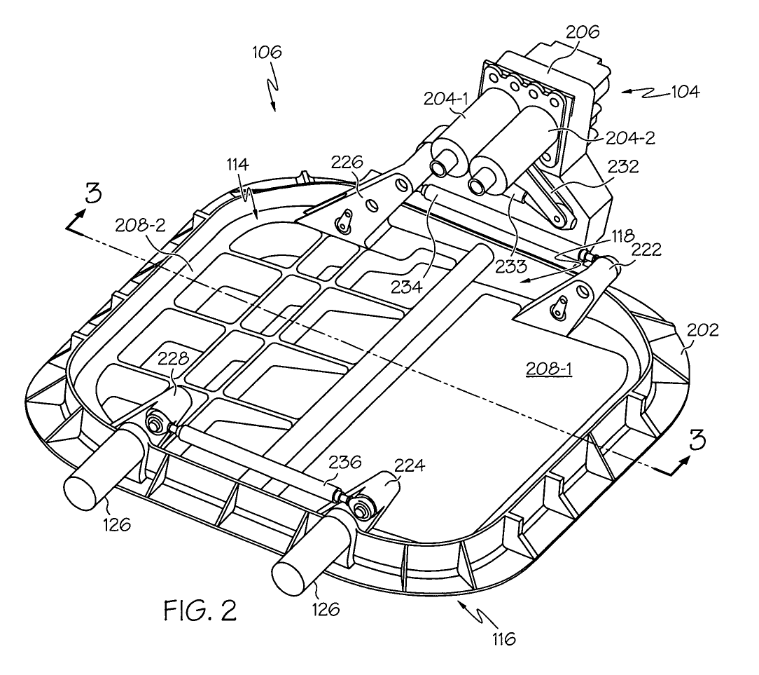

Turning now to FIGS. 2-4, an exemplary embodiment of a particular physical implementation of the outflow valve 106 is depicted. The outflow valve 106 includes a frame 202, the valve element 118, and a plurality of position sensors 126. The frame 202 is configured to be mounted on the aircraft exterior skin 122, and includes the inlet flow port 114 and the outlet flow port 116. The valve element 118 is rotationally coupled to the frame 202, and is coupled to receive an actuation drive force from the actuator 104. In the depicted embodiment, the actuator 104 is mounted on the outflow valve 106, and is more particularly coupled to an outer peripheral portion of the frame 202. Although the actuator 104 may be variously configured and implemented, in the depicted embodiment, the actuator 104 is implemented using a plurality of electrical motors 204 (e.g., 204-1, 204-2) and a gear set 206. The motors 204 are each adapted to receive actuation commands from the controller 102 (not shown in FIGS. 2-4) and are each operable, upon receipt thereof, to supply a drive torque. The gear set 206 is coupled between each of the motors and the valve element 118, and receives the drive torque from one or both of the motors 204. The gear set 206, upon receipt of the drive torque from one or both of the motors 204, supplies the actuation drive force to the valve element 118.

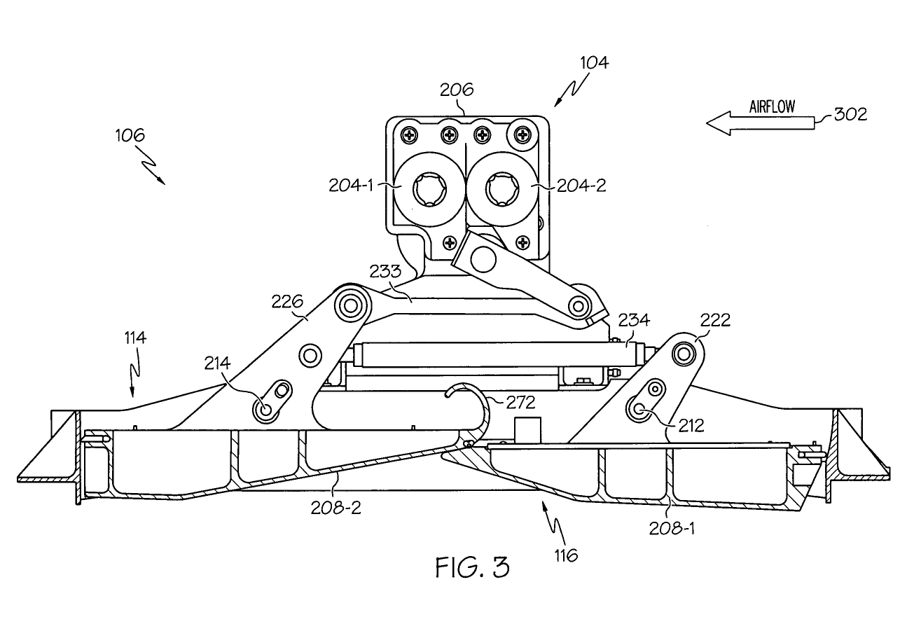

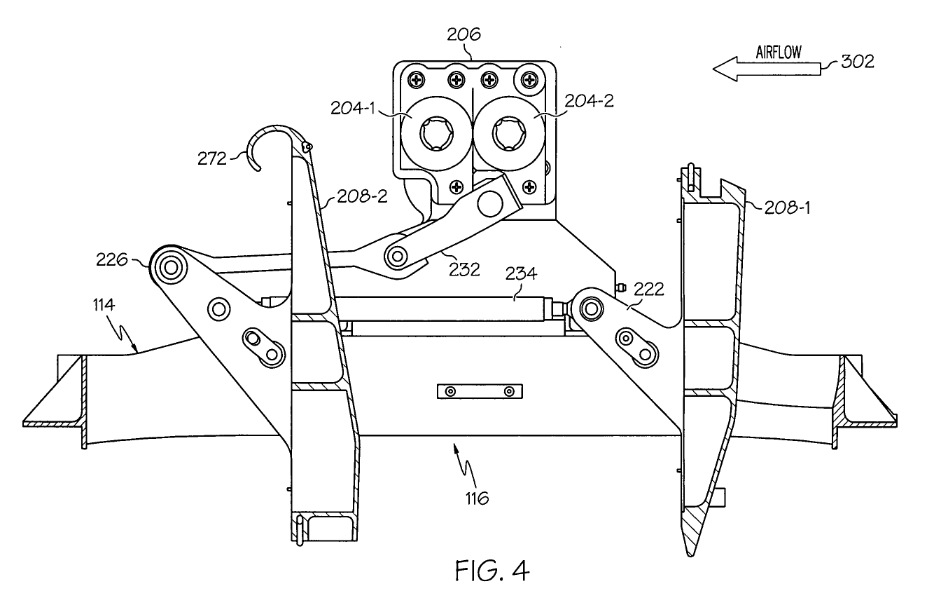

The valve element 118, in response to the actuation drive force it receives from the actuator 104, rotates to a position between a closed position and a plurality of open positions. It is noted that the position of the valve element 118 during flight is typically a partially open position, intermediate the fully closed position (shown in FIG. 3) and fully open position (shown in FIG. 4). Although the valve element 118 may be variously configured and implemented, in the depicted embodiment the valve element is implemented using two doors 208—a first door 208-1 and a second door 208-2—that are each rotationally coupled to the frame 202.

Before proceeding further, it was noted above that in some embodiments the outflow valve 106 may be located in the rear underbelly of the aircraft proximate the tail. Moreover, and as shown most clearly in FIGS. 3 and 4 via airflow arrow 302, the outflow valve 106 is preferably mounted such that first door 208-1 is closer to the front of the aircraft than the second door 208-2. For this reason, the first door 208-1 and second door 208-2 may also be referred to herein as the forward door 208-1 and the aft door 208-2, respectively.

Returning once again to the description, and as shown more clearly in FIGS. 3 and 4, the forward door 208-1 is rotationally coupled to the frame 202 via a plurality of first valve pins 212 (only one visible), and the aft door 208-2 is rotationally coupled to the frame 202 via a plurality of second valve pins 214 (only one visible). More particularly, the forward door 208-1 is coupled to the first valve pins 212, which are disposed within suitable openings in the frame 202 and are configured to rotate relative to the frame 202, and the aft door 208-2 is coupled to the second valve pins 214, which are also disposed within suitable openings in the frame 202 and are configured to rotate relative to the frame 202. A more detailed description of particular configurations of the first and second valve pins 212 and 214 will be provided further below.

As FIGS. 2-4 additionally depict, the first door 208-1 includes first and second arms 222 and 224 that extend outwardly therefrom, and the aft door 208-2 includes first and second arms 226 and 228 that extend outwardly therefrom. The aft door first arm 226 is coupled to the actuator 104, and more particularly the gear set 206, via an input link 232 (e.g., a bell crank type linkage) and primary push rod 233. The forward door first and second arms 222 and 224 are coupled to aft door first and second arms 226 and 228, respectively, via first and second slave links 234 and 236. It will be appreciated that in alternative embodiments, only a single slave link 234 or 236 may be used. In any case, the result of this coupling is that the forward and aft doors 208 rotate substantially simultaneously when driven by the actuator 104.

For completeness of description, it is noted that when the valve element 118 is rotated into the fully open position (FIG. 4) or a partially opened position (not shown), and cabin pressure is greater than the outside atmospheric pressure, pressurized air flows from the aircraft cabin 112, past the forward and aft doors 208-1 and 208-2, and to the outside atmosphere 124. The depicted outflow valve 106 is designed such that the pressurized flow is relatively smooth (non-turbulent), quiet, and rapid. As depicted in FIG. 4, when valve element 118 is in the fully open position or a partially opened position (not shown), the inner sealing edge of forward door 208-1 protrudes into the pressurized airstream. Thus, to promote laminar flow through the frame 202 and past the forward 208-1 and aft 208-2 doors, a curved bellmouth 272 is fixedly coupled to the depicted forward door 208-1 proximate the sealing edge of the forward door 208-1. Due to its curved geometry, the upstream face of the bellmouth 272 conditions pressurized airflow through outflow valve 106 to promote laminar flow, to decrease the production of noise, and to increase the production of forward thrust. The bellmouth 272 may be designed to provide optimal flow conditioning in its normal cruise position, which may be, for example, a partially open position offset from the fully closed position (FIG. 3) by an angular displacement of approximately 1-5 degrees.

The position sensors 126, as noted above, are coupled to the frame 202. As was also noted above, the position sensors 126 are configured to directly sense rotation of the valve element 118 and supply a position signal representative of valve element position. To do so, each position sensor 126 is preferably configured to sense rotation of one of the first valve pins 212 or one of the second valve pins 214. In the depicted embodiment, one position sensor 126 is coupled to the frame 202 and is configured to sense rotation of one of the first valve pins 212, and a second position sensor 126 is coupled to the frame 202 and is configured to sense rotation of one of the second valve pins 214. It will be appreciated that in other embodiments additional position sensors 126 may be coupled to the frame 202 so that rotation of each of the first valve pins 212 and each of the second valve pins 214 may be independently sensed.

No matter whether one or a plurality of position sensors 126 is used, each position sensor 126 may be implemented using any one of numerous position sensors now known or developed in the futures. For example, any one of numerous types of magnetic, optical, electromagnetic, electromechanical, and resistance type sensors may be used. In some embodiments, the position sensor 126 may include a moving element that is coupled to, or formed as an integral part of, the appropriate valve element pin 212 or 214, and a fixed sensing element that senses the rotation of the moving element. As one example of this, an exemplary magnetic position sensor 126 is depicted in cross section in FIG. 5. As shown therein, the position sensor 126 includes a magnetic element 502 that is coupled to the valve element pin 212 (214), and thus rotates therewith. The position sensor 126 additionally includes a sensing element 504 that senses the rotation of the magnetic element 502, and thus the rotation of the forward door 208-1 (aft door 208-2). Again, however, it should be emphasized that this is merely exemplary of any one of numerous configurations and implementations of the position sensor 126.

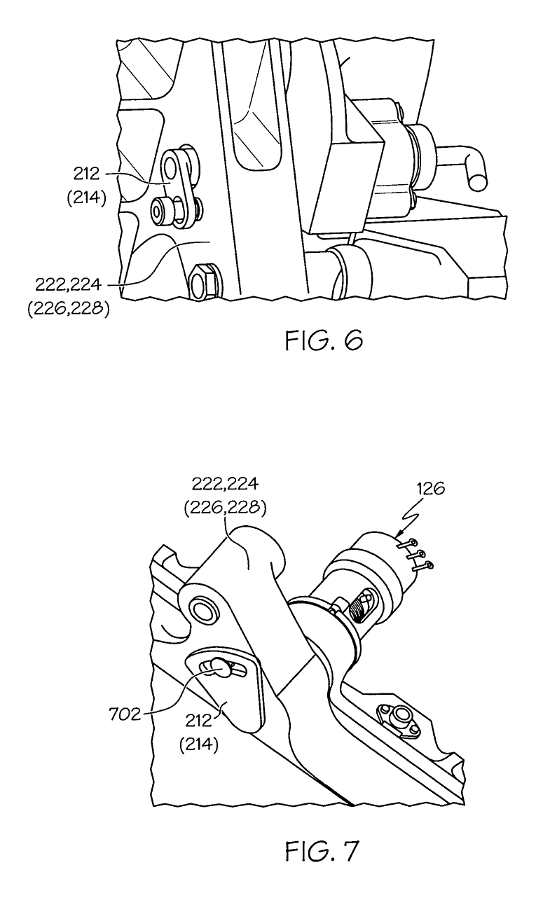

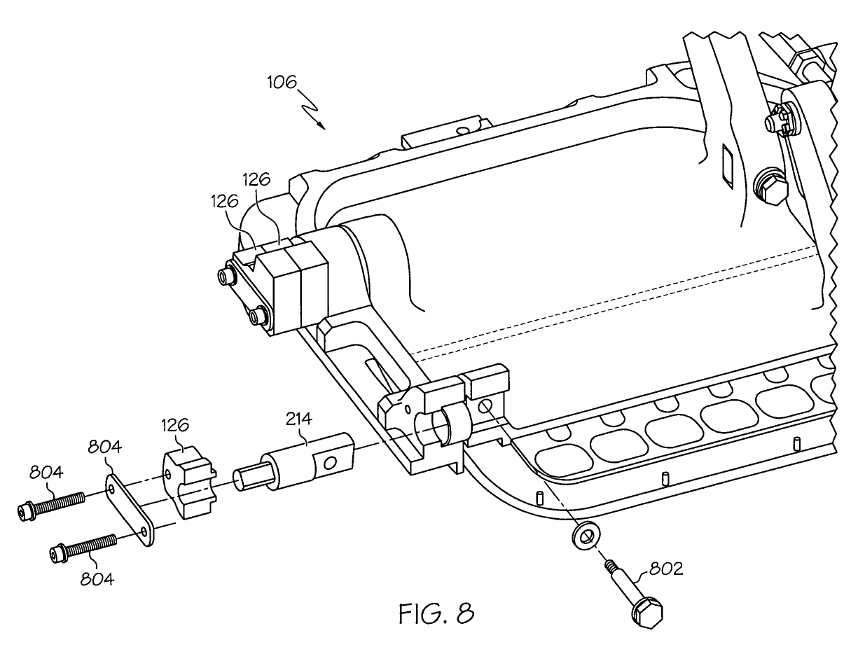

With reference now to FIGS. 6 and 7, it is seen that the configuration of at least a portion of the valve pins 212, 214 may also vary. For example, it is seen that in each of these exemplary depicted embodiments that the valve pin 212 (214) is clocked to the forward door 208-1 (aft door 208-2), and more specifically one of the arms 222 or 224 (or 226 or 228) extending from the forward door 208-1 (or aft door 208-2). Moreover, in the embodiment depicted in FIG. 7, the valve pin 212 (or 214) is adjustably clocked to the forward door 208-1 (or aft door 208-2) via a suitable fastener 702.

In addition to variations in the configurations of the valve pins 212, 214, the configuration of the valve itself may also vary. For example, FIG. 8 depicts a slightly modified valve configuration. In this embodiment, the forward and aft doors 208-1, 208-2 do not include second arms 224, 228 that extend outwardly therefrom. Moreover, it is seen that the valve pins 212 and 214 are clocked to the forward and aft doors 208-1 and 208-2, respectively, via fasteners 802 that extend perpendicularly through the valve pins 212, 214.

It is noted that in the embodiment depicted in FIG. 8, that the depicted sensors 126 are implemented using suitable potentiometer sensors that are coupled to the valve 106 via suitable mounting hardware 804, though any one of numerous other suitable rotational position sensing devices and mounting hardware may also be used. This embodiment is also depicted with two position sensors 126 associated with the forward door 208-1 and a single sensor 126 associated with the after door 208-2. Again, it will be appreciated that this is merely exemplary, and that a single position sensor 126 could be associated with each door 208, or one of the doors 208 could have no associated position sensors 126. It will additionally be appreciated that if two (or more) position sensors are associated with a single door 208, then the associated valve pin 212 or 214 may preferably be configured longer that the other valve pins 212 or 214.

While described above in the context of an exemplary cabin pressure control system, it should be appreciated that embodiments of the outflow valve may be utilized in various other avionic and non-avionic applications where it is desirable to provide accurate, direct position indication of a valve element. In such alternative applications, the outflow valve may be utilized to regulate the flow of fluids other than pressurized air. Furthermore, although the above-described exemplary outflow valve employed two (i.e., forward and aft) rotatable doors, alternative embodiments of the outflow valve may include any suitable number of rotatable doors or other such valve elements.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An aircraft cabin pressure control system thrust recovery outflow valve, comprising:
a frame configured to be mounted on an aircraft exterior skin;
a valve element rotationally coupled to the frame, the valve element coupled to receive an actuation drive force and responsive thereto to rotate to a position between a closed position and a plurality of open positions; and
a position sensor coupled to the frame and configured to directly sense rotation of the valve element and supply a position signal representative of valve element position.

2. The thrust recovery outflow valve of claim 1, further comprising:
a plurality of valve pins coupled to the valve element and configured to rotate therewith,
wherein the position sensor is configured to sense rotation of one of the valve pins.

3. The thrust recovery outflow valve of claim 1, wherein:
the valve element comprises a plurality of doors, each door rotationally coupled to the frame and responsive to the actuation drive force to rotate to a position between a closed position and a plurality of open positions; and
the position sensor is configured to directly sense rotation of one of the doors.

4. The thrust recovery outflow valve of claim 3, further comprising:
a second position sensor coupled to the frame and configured to directly sense rotation of another one of the doors and supply a second position signal representative of valve element position.

5. The thrust recovery outflow valve of claim 4, wherein the valve element comprises a first door and a second door.

6. The thrust recovery outflow valve of claim 5, wherein the first and second doors are coupled together in a manner that the first and second doors are responsive to the actuation drive force to simultaneously rotate.

7. The thrust recovery outflow valve of claim 1, further comprising:
an actuator coupled between the frame and the valve element, the actuator adapted to receive actuation commands and operable, in response thereto, to supply the actuation drive force to the valve element.

8. The thrust recovery outflow valve of claim 7, wherein the actuator comprises:
a plurality of motors, each motor adapted to receive actuation commands and operable, upon receipt thereof, to supply a drive torque; and
a gear set coupled between each of the motors and the valve element, the gear set coupled to receive the drive torque from the motor and operable, upon receipt thereof, to supply the actuation drive force to the valve element.

9. An aircraft cabin pressure control system thrust recovery outflow valve, comprising:
a frame configured to be mounted on an aircraft exterior skin;
an actuator coupled to the frame and operable to supply an actuation drive force;
a first door rotationally coupled to the frame and further coupled to receive the actuation drive force supplied by the actuator, the first door responsive to the actuation drive force to rotate to a position between a closed position and a plurality of open positions;
a second door rotationally coupled to the frame and further coupled to the first door, the second door responsive to rotation of the first door to simultaneously rotate therewith to a position between a closed position and a plurality of open positions; and
a first position sensor coupled to the frame and configured to directly sense rotation of the first door and supply a position signal representative of first door position; and
a second position sensor coupled to the frame and configured to directly sense rotation of the second door and supply a position signal representative of second door position.

10. The thrust recovery outflow valve of claim 9, further comprising:
a plurality of first valve pins coupled to the first door and configured to rotate therewith; and
a plurality of second valve pins coupled to the second door and configured to rotate therewith,
wherein the first position sensor is configured to sense rotation of one of the first valve pins, and the second position sensor is configured to sense rotation of one of the second valve pins.

11. The thrust recovery outflow valve of claim 9, further comprising:
an actuator coupled between the frame and the first door, the actuator adapted to receive actuation commands and operable, in response thereto, to supply the actuation drive force to the first door.

12. The thrust recovery outflow valve of claim 11, wherein the actuator comprises:
a plurality of motors, each motor adapted to receive actuation commands and operable, upon receipt thereof, to supply a drive torque; and
a gear set coupled between each of the motors and the valve element, the gear set coupled to receive the drive torque from the motor and operable, upon receipt thereof, to supply the actuation drive force to the valve element.

13. An aircraft cabin pressure control system, comprising:
a controller;
an actuator coupled to receive actuation commands from the controller and operable, in response thereto, to supply an actuation drive force; and
a thrust recovery outflow valve coupled to receive the actuation drive force, the thrust recovery outflow valve comprising:
a frame configured to be mounted on an aircraft exterior skin,
a valve element rotationally coupled to the frame, the valve element coupled to receive the actuation drive force and responsive thereto to rotate to a position between a closed position and a plurality of open positions, and
a position sensor coupled to the frame and configured to directly sense rotation of the valve element and supply a position signal representative of valve element position.

14. The system of claim 13, further comprising:
a plurality of valve pins coupled to the valve element and configured to rotate therewith,
wherein the position sensor is configured to sense rotation of one of the valve pins.

15. The system of claim 13, wherein:
the valve element comprises a plurality of doors, each door rotationally coupled to the frame and responsive to the actuation drive force to rotate to a position between a closed position and a plurality of open positions; and
the position sensor is configured to directly sense rotation of one of the doors.

16. The system of claim 15, further comprising:
a second position sensor coupled to the frame and configured to directly sense rotation of another one of the doors and supply a second position signal representative of valve element position.

17. The system of claim 16, wherein the valve element comprises a first door and a second door.

18. The system of claim 17, wherein the first and second doors are coupled together in a manner that the first and second doors are responsive to the actuation drive force to simultaneously rotate.

19. The system of claim 13, further comprising:
an actuator coupled between the frame and the valve element, the actuator adapted to receive actuation commands and operable, in response thereto, to supply the actuation drive force to the valve element.

20. The system of claim 19, wherein the actuator comprises:
a plurality of motors, each motor adapted to receive actuation commands and operable, upon receipt thereof, to supply a drive torque; and
a gear set coupled between each of the motors and the valve element, the gear set coupled to receive the drive torque from the motor and operable, upon receipt thereof, to supply the actuation drive force to the valve element.
